(19) United States
(12) Patent Application Publication
(10) Pub. No.: US 2015/0136616 A1
(43) Pub. Date: May 21, 2015

(54) MEASURING APPARATUS AND METHOD FOR DETECTING THE HYDROCARBON FRACTION IN GASES WHILE TAKING INTO ACCOUNT CROSS-SENSITIVITIES

(71) Applicant: BEKO TECHNOLOGIES GMBH, Neuss (DE)

(72) Inventor: Martin Friedrich, Loffingen (DE)

(21) Appl. No.: 14/401,027

(22) PCT Filed: May 29, 2013
(86) PCT No.: PCT/EP2013/061130

§ 371 Date: Nov. 13, 2014

(30) Foreign Application Priority Data
May 30, 2012 (DE) 10 2012 010 613.0

(51) Int. Cl. G01N 27/404

(52) U.S. Cl. CPC G01N 27/4045
USPC 205/785.5; 204/406

(57) ABSTRACT

The disclosure relates to a measuring apparatus and method for determining a measured value in a gas flow accounting for cross-sensitivities of the measuring appliance from at least one additional constituent in the gas flow interfering with the measured value. The measuring apparatus has a device for dividing original gas flow to be measured into a first and second measured gas flows, a device for changing the content of measured gas in the second measured flow by changing an influencing variable that influences the content of the measured gas, and a sensor element having a sensor for determining the value. The apparatus includes an evaluating unit for evaluating the measured values, wherein first and second measured flows are alternately fed to the sensor element to determine two intermediate measured values in two measured flows, respectively. The evaluating unit calculates the final value based on the two intermediate measurement results.

### FIELD

The disclosure relates to a measuring apparatus and a method for determining a measured value in a gas flow taking cross-sensitivities in the measuring system into consideration due to at least one further constituent in the gas flow interfering with the measured value of the measured gas.

### BACKGROUND

Cross-sensitivity is the sensitivity of a measuring apparatus to variables other than the measured variable or the measured value, i.e. the variable to be measured. A variable which is not a measured variable but which has an influence on the information delivered by the measuring system via the measured value is termed the influencing variable. This means that only the measured value varies when the influencing variable varies.

Cross-sensitivity also encompasses imperfect selectivity, as occurs, for example, with gas sensors. These often also respond to concentrations of gases other than the gas to be detected.

Examples of important influencing variables are temperature, humidity, air pressure, electrical field or magnetic field.

One possibility for taking cross-sensitivities into consideration or for correcting errors in measurements caused by cross-sensitivities is to provide a plurality of sensors, determining the individual measured values separately from each other and then comparing the measured values and correcting them. This results in comparatively high costs and high-maintenance measuring apparatus.

Thus, a need exists for providing a measuring apparatus and a method for determining a measured value in a gas flow which at least substantially, but possibly completely eliminates interfering cross-sensitivities of the measuring system due to at least one further constituent in the gas flow which has an influence on the measured value of the measured gas. The measuring apparatus should be capable of being installed and also have a low susceptibility for error.

### SUMMARY

The aim is accomplished by means of a measuring apparatus for determining a measured value in a gas flow, taking into consideration cross-sensitivities of the measuring system due to at least one further constituent in the gas flow which interferes with the measured value of the measured gas, which comprises
a device for dividing an original flow of gas to be measured into a first flow of measured gas and a second flow of measured gas,
a device for varying the measured gas content in the second flow of measured gas by varying an influencing variable which influences the measured gas content,
a sensor element with a sensor for determining the measured value,
an evaluating unit for evaluating the measured variables,

wherein
the first flow of measured gas or the varied second flow of measured gas is fed alternately to the sensor element in order to determine a first intermediate measured value in the first flow of measured gas and to determine an intermediate measured value in the second flow of measured gas,
the evaluating unit calculates the final measured value on the basis of the results of the two intermediate measurements.

The aim of the disclosure is also accomplished by means of a method for determining a measured gas content in a gas flow taking into consideration cross-sensitivities of the measuring system due to at least one further constituent in the gas flow which interferes with the measured value of the measured gas, which is characterized by the following steps of the method:
dividing an original flow of gas to be measured into at least a first flow of measured gas and a second flow of measured gas,
varying the measured gas content in the second flow of measured gas by varying an influencing variable which influences the quantity of measured gas,
feeding the first flow of measured gas and the second flow of measured gas to a sensor in alternation,
determining a first intermediate measured value in the first flow of measured gas which represents the sum of the content of the measured gas and the content of the interfering further constituent,
determining a second intermediate measured value in the second flow of measured gas which represents the sum of the content of the measured gas and the content of the interfering further constituent,
calculating the final measured value based on the results of the two intermediate measurements.

In accordance with the disclosure, the original flow of gas to be measured is divided into a first flow of measured gas and a second flow of measured gas. Dividing the original gas flow can be accomplished by actual physical division, for example using a separator; alternatively, the original gas flow can, for example, be fed in alternation to the sensor element with the aid of valves.

The disclosure is based on the assumption that two gases are present in the original gas flow which have an influence on the final measured value because of their cross-sensitivity. If, for example, the quantity of the first gas in the original gas flow is to be determined, the presence of the second gas influences the final measured value, then this constitutes the interfering further constituent.

The disclosure is based on the concept that the original gas flow is initially divided into two flows of measured gas and influencing one of the flows of measured gas by varying an influencing variable which influences the content of the measured gas. In this manner, using only one sensor element, two measurements can be carried out which lead to different results. However, if the change in the second flow of measured gas is known, if, for example, the measured gas is reduced or completely removed, then the actual measured value can be calculated from the two intermediate measured variables.

The disclosure is of particular application to a measuring apparatus for determining sulphur dioxide (SO₂) in a measured gas, which also contains nitrogen dioxide (NO₂). A sulphur dioxide sensor has a high cross-sensitivity with nitrogen dioxide. What is particularly difficult is that the sensor has approximately the same degree of sensitivity for both gases, but the output signal for nitrogen dioxide is negative. Thus, if the measured gas contains the same quantity of sulphur dioxide and nitrogen dioxide, then the output signal is approximately zero.

Sulphur dioxide is almost completely soluble in water and after passing through a humidifying element, preferably in association with a membrane, for example a bundle of hollow fibres flushed with water (membrane humidifier), it is almost completely removed. Nitrogen dioxide, on the other hand, is not soluble in water, and thus on exiting the humidifying element, it is still present in its entirety.

In accordance with the disclosure, the first flow of measured gas is fed directly to the sensor element, but the second flow of measured gas is only sent after passing through the humidifying element. By switching between the dry first flow of measured gas and the humidified second flow of measured gas, then, two different measured variables are obtained:

1. in a dry measured gas, the total value for sulphur dioxide together with nitrogen dioxide (first intermediate measured value), wherein the nitrogen dioxide has a negative sign in the total value.

2. for humidified gas, only the value for the cross-sensitivity to other gases apart from sulphur dioxide (typically nitrogen dioxide, the second intermediate measured value).

Next, if the second intermediate measured value (with the opposite sign, i.e. in effect an addition) is now subtracted from the first intermediate measured value, the actual final measured value for the sulphur dioxide content of the measured gas is obtained.

An essential advantage of the disclosure is found, inter alia, in the fact that by assuming that, apart from nitrogen dioxide in the measured gas, there are no other gases present to which the sulphur dioxide sensor exhibits a cross-sensitivity, the sulphur dioxide sensor can also be used as a nitrogen dioxide sensor or measuring cell. Thus, the costs are significantly reduced, along with maintenance over the service life of the measuring apparatus.

The gas humidification using a membrane humidifier with hollow fibre membranes is particularly advantageous, in particular in the field of respiratory gas measurement. A membrane humidifier of this type is inexpensive to manufacture and also functions very reliably over long periods of service. Moreover, it has a low specific weight. The bundle of hollow fibres is advantageously flushed with water which has been softened before it enters the membrane humidifier in order to prevent deposits of lime in the membrane humidifier, for example by using a mixed bed cartridge.

The water supply can be supplied in a periodic manner via a valve; for example, it could be opened every hour for approximately 10 seconds. The waste water is fed into the drains.

In accordance with the disclosure, humidification is carried out at approximately 2 bar over-pressure. The moisture content at the outlet is almost 100% relative humidity at 2 bar over-pressure. After expansion to ambient pressure, the relative humidity becomes approximately 40% relative humidity.

The measuring apparatus can be calibrated by means of one, preferably two reference gases which are provided via external compressed gas bottles. It is possible to carry out a gain correction, an offset correction and also a combined gain and offset correction.

For calibration, the measured gas is switched off via valves and at the same time, switched to one of the reference gases which act as calibration gases. Thus, during the calibration procedure, it is possible to switch between humidified and dry reference gas.

In an advantageous measuring apparatus in accordance with the disclosure, the sensor element is provided with further sensors with which, for example, in addition to the nitrogen dioxide and sulphur dioxide contents, the carbon monoxide, nitric oxide, carbon dioxide and oxygen contents can be determined. These sensors too may be capable of being calibrated using reference gas.

The carbon dioxide sensor has a low tolerance to moisture. Thus, in accordance with the disclosure, this sensor is only operated with dry measured gas. The electrochemical gas sensors, on the other hand, must not be operated with dry air alone, since the electrolyte would dry out. The carbon monoxide, nitrogen dioxide and oxygen sensors are thus always operated with humidified air. Since these gases do not dissolve in water, this measured value is not distorted by the moisture.

Sulphur dioxide dissolves in water and thus, as it passes through the humidifying element, it is almost completely absorbed out of the gas. Thus, valves are periodically switched between dry and humidified measured gas. On average, measuring gas at approximately 20% relative humidity arrives at the sensor element in this embodiment, which is sufficient to prevent the cells from drying out during their service life.

Advantageously, an oxygen volumetric calculation (vol %) is carried out, wherein the partial pressure dependency is corrected by the measured ambient pressure. This also improves the accuracy in the measurement, since the output signal for the measuring cell (flow signal) is a function of the partial pressure of O₂.

In addition, in accordance with the disclosure, the tolerance to moisture of the oxygen volumetric calculation (vol %) is compensated for by the measured ambient humidity. This also improves the accuracy in the measurement, since the output signal for the oxygen measuring cell (flow signal) is relatively significantly dependent on the relative gas humidity.

Advantageously, the measuring apparatus comprises an amperometric lead-free oxygen measuring cell which has an exceptionally long lifespan. This is also because the sensor element which is normally used is in principle a galvanic lead-air cell in which the lead electrode is consumed by measurement of the oxygen. The lifespan of lead cells is greatly dependent on the partial pressure of oxygen and on the temperature, as well as on the storage period and the storage conditions (storage with the exclusion of air). The amperometric measuring cell does not suffer from these disadvantages; the cell is not consumed, since the electrolyte is regenerated by the reaction at the counter-electrode.

In accordance with the disclosure, a carbon dioxide volume calculation (vol %) is also carried out, in which the dependency of the partial pressure is corrected by the measured ambient pressure. The operating principle of the carbon dioxide sensor is an optical NDIR measurement procedure. The absorption of IR light is dependent on the density of the gas (and thus on the partial pressure). By measuring the ambient pressure, the accuracy of the measurement between the calibration intervals is improved.

During offset correction in accordance with the disclosure, the TCO (temperature compensation offset) of the amperometric measuring cells (apart from for oxygen measurement) is corrected by a fourth electrode. The required accuracy in the measurement is only made possible by means of this optimization of the measuring cell and measuring the zero level in the electrolyte.

During gain correction in accordance with the disclosure, the TCG (temperature compensation gain) of the amperometric measuring cells in the service temperature range is calibrated. This is carried out by measuring or calibrating the gas concentration within the limits for a plurality of different temperatures and correcting by computer. A corrective value can be determined by calibrating the gain in the measuring cells with reference to the factory calibration. The contribution of the corrective value can provide information regarding ageing of the measuring cell and a request for servicing can be prompted. This method means that it is possible to determine the condition of the cells as they age. Despite ageing and the reduced sensitivity, after calibrating the gain, correct variables can again be measured. In this manner, it is possible to optimize maintenance intervals.

Self-testing of the apparatus is carried out periodically. During the self-test, all of the gas channels and volume flows are checked. This is an important performance characteristic for increasing the reliability of the apparatus. In the event of a closed gas channel, the measuring cell would not in fact emit an alarm upon exceeding the limits and the error would not be noticed.

Advantageously, humidification is constantly monitored. If humidification fails, the gas channels are switched off in order to protect the measuring cells, which would otherwise dry out after a few hours of dry operation. This feature also increases the reliability of the apparatus, since a dried-out measuring cell delivers a zero signal and thus the positive sounding of an alarm would not be guaranteed. In addition, dry operation would give rise to considerable damage.

In accordance with the disclosure, it is possible to operate using a water tank, so that it can operate independently of an external water supply. Ideally, the water level in the tank is monitored and if the level drops too low, a service request is triggered. This possibility for supplying water means that the installation costs to the consumer are lower if there is no water supply in the vicinity of the apparatus.

In the disclosure, the service intervals are also monitored and a service request is displayed externally. For operational safety reasons, regular maintenance is indispensable. Because the service intervals are monitored automatically, breakdown of the apparatus due to forgetting to carry out maintenance is avoided.

Advantageously, the steam concentration by weight is measured; in another embodiment, it is carried out by means of an aluminum oxide humidity sensor, which covers the measurement range significantly better than a polymeric humidity sensor. The measurement range to −60 C td, f is thus obtainable. A polymer sensor can only guarantee accurate results to approximately −40 C td, f. The accuracy of a polymer sensor is not sufficient, particularly at high operating temperatures.

By means of the second reference gas connection, in accordance with the disclosure, calibration of the gain of the measuring cells and thus compensation for ageing is possible, which again results in lengthier maintenance intervals.

Advantageously, the measuring apparatus is provided with an internal data logger for recording the measurement data. This means that histories can be archived in the apparatus independently of external systems. In a particularly advantageous embodiment, an internal event logger is installed to record events. This feature means that analyses of hidden errors or errors which arise between service intervals are possible.

### BRIEF DESCRIPTION OF THE FIGURES

FIG. 1 shows a first simplified schematic diagram of a measuring apparatus in accordance with the disclosure; and

FIG. 2 shows a second simplified schematic diagram of the measuring apparatus in accordance with the disclosure.

### DETAILED DESCRIPTION OF THE FIGURES

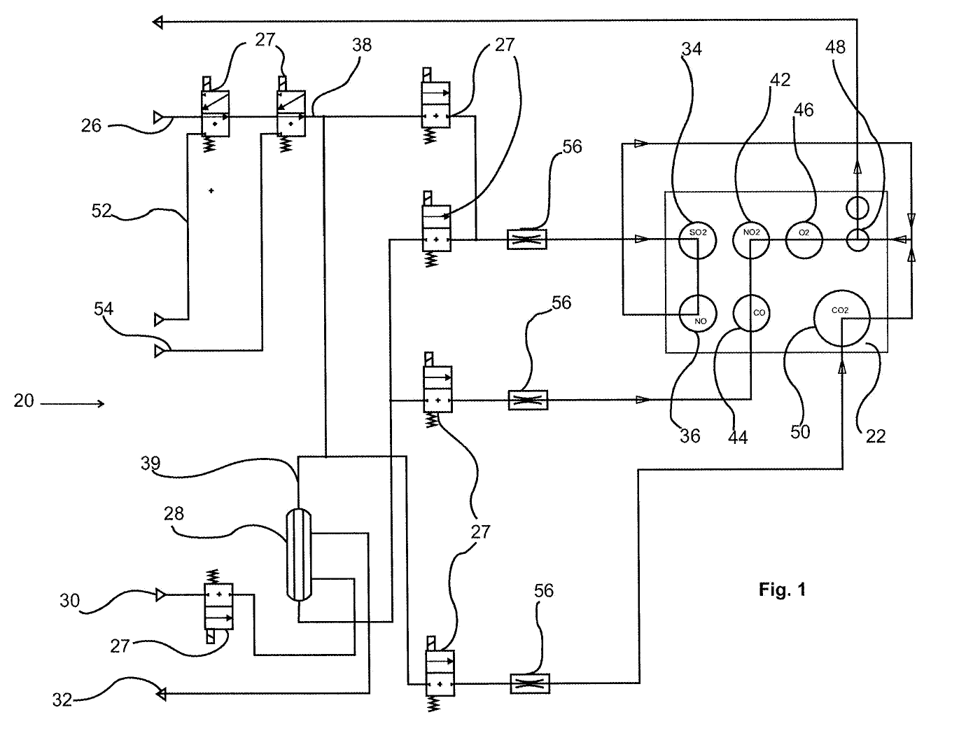

FIG. 1 shows a schematic of the essential elements of a measuring apparatus 20 in accordance with the disclosure. It comprises a sensor element 22 with a variety of sensors.

An original gas flow 26 is divided into a first flow of measured gas 38 and a second flow of measured gas 39 with the aid of valves 27 and gas lines. In the embodiment shown, the original gas flow 26 is divided over time; dividing it into two separate volumetric flows is also possible.

The first flow of measured gas 38 is supplied directly to the sensor element 22, the second flow of measured gas 39, on the other hand, is initially fed to a humidifying element, preferably a membrane humidifier 28. The membrane humidifier 28 comprises a water inlet 30 and a water outlet 32. Next, the humidified second gas flow 39 also reaches the sensor element 22. The water supply can be provided periodically via a valve 27; as an example, it could be opened every hour for approximately 10 seconds. The quantity of water is approximately 100 mL. The annual consumption is thus only approximately 876 litres. A mixed bed cartridge (not shown) of appropriate size for this quantity of water is provided and is relatively small as it only has a volume of approximately 200 mL.

The sensor element comprises various sensors, including a sulphur dioxide sensor 34 (SO₂ sensor), a nitric oxide sensor 36 (NO sensor), a nitrogen dioxide sensor 42 (NO₂ sensor), a carbon monoxide sensor 44 (CO sensor), an oxygen sensor (O₂ sensor) 46, a temperature sensor 48 and a carbon dioxide sensor 50 (CO₂ sensor). In accordance with the disclosure, in contrast to the embodiment shown, assuming that apart from nitrogen dioxide in the measured gas, no other gases are present for which the sulphur dioxide sensor 34 has a cross-sensitivity, the sulphur dioxide sensor 34 can also determine the nitrogen content, and so the nitrogen dioxide sensor 42 can be dispensed with.

The nitrogen dioxide sensor 42 is more selective than the sulphur dioxide sensor 34 and provides substantial advantages. With respect to use in compressed air units in which only gas contamination is usually the case, and for which no cross-sensitivities arise, the selectivity is not absolutely necessary, so that the measured value for the sulphur dioxide sensor 34 for the humidified gas flow can be used for both the nitrogen dioxide compensation of the sulphur dioxide measured value and also for the nitrogen dioxide measurement. The requirement in this event is that the humidifying element removes all of the sulphur dioxide, as otherwise the nitrogen dioxide measured value would be distorted by the remaining quantity of sulphur dioxide. Experimental results have shown that this is indeed the case.

The first flow of measured gas 38 is fed to the sulphur dioxide sensor 34, the nitric oxide sensor 36 and the carbon dioxide sensor 50.

The second flow of measured gas 39 is fed to the sulphur dioxide sensor 34, the nitric oxide sensor 36 and the other sensors apart from the carbon dioxide sensor 50.

The measuring apparatus 20 can be calibrated using two reference gas flows 52, 54 which are provided via external compressed gas bottles.

The measuring apparatus 20 is also provided with a plurality of flow control valves 56.

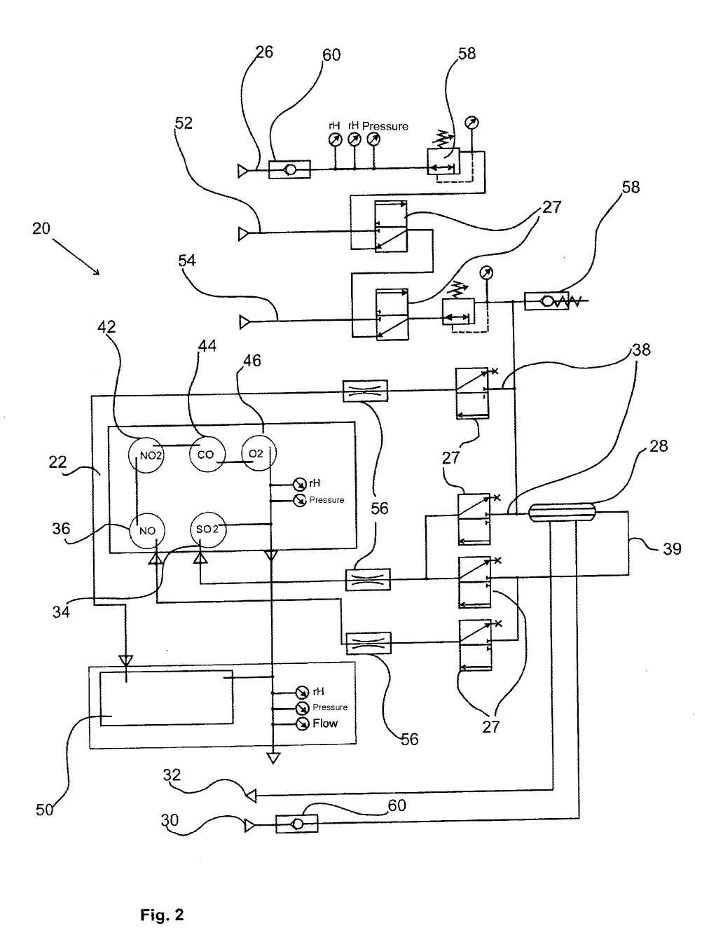

FIG. 2 shows a second variation of the disclosure. This differs from the variation of FIG. 1 as follows:
the sulphur dioxide sensor 34 and the nitric oxide sensor 36 can be operated dry/wet in alteration,
more measuring points for secondary measured values (flow, pressure, humidity) are present,
instead of 2/2 valves, 3/2 valves are provided,
a pressure regulator is provided in the original gas flow 26,
an over-pressure valve 58 is provided,
non-return valves 60 are provided in the original gas flow 26 and in the water supply 30,
the carbon dioxide measurement is carried out separately.

The differences are essentially practical optimizations in order to expand the range of application or to improve the safety of the technology.

The disclosure is not limited to the embodiments described, which are provided merely to illustrate the disclosure.

1. A measuring apparatus for determining a measured value in a gas flow, taking into consideration cross-sensitivities of the measuring system due to at least one further constituent in the gas flow which interferes with the measured value of the measured gas, comprising:
a device for dividing an original flow of gas to be measured into a first flow of measured gas and a second flow of measured gas,
a device for reducing the measured gas content in the second flow of measured gas by varying an influencing variable which influences the measured gas content, wherein the influencing variable is the humidity,
a sensor element with a sensor for determining the measured value, and
an evaluating unit for evaluating the measured variables,
wherein
the first flow of measured gas or the varied second flow of measured gas is fed alternately to the sensor element in order to determine a first intermediate measured value in the first flow of measured gas and to determine a second intermediate measured value in the second flow of measured gas,
the evaluating unit calculates the final measured value on the basis of the results of the first and second intermediate measured values.

2. (canceled)

3. The measuring apparatus according to claim 1, wherein it is provided as a medical respiratory gas measuring apparatus.

4. The measuring apparatus according to claim 1, wherein the sensor element further includes at least one sensor for determining the sulphur dioxide and nitrogen dioxide contents, wherein sulphur dioxide constitutes the measured gas and the device for varying the measured gas content varies the sulphur dioxide content in the second flow of measured gas.

5. The measuring apparatus according to claim 3, wherein the device varies the humidity of the second flow of measured gas in a manner such that sulphur dioxide is removed from the second flow of measured gas.

6. The measuring apparatus according to claim 1, wherein a calibration gas can be fed to the sensor element in addition to the flows of measured gas.

7. The measuring apparatus according to claim 1, wherein the sensor element further includes sensors for determining the content of further different gases.

8. The measuring apparatus according to claim 6, wherein the sensor element further includes sensors for determining the carbon monoxide, nitric oxide, nitrogen dioxide, sulphur dioxide, carbon dioxide and oxygen contents.

9. The measuring apparatus according to claim 7, wherein the sensors for determining the sulphur dioxide content deal exclusively with the first flow of measured gas and the sensors for determining the carbon monoxide and oxygen contents deal exclusively with the second flow of measured gas.

10. The measuring apparatus according to claim 1, wherein the device for varying the measured gas content in the second flow of measured gas is formed by a bundle of hollow membrane fibres which is flushed with water.

11. A method for determining a measured gas content in a gas flow, taking into consideration cross-sensitivities of the measuring system due to at least one further constituent in the gas flow which interferes with the measured value of the measured gas, the method including the following steps:
dividing an original flow of gas to be measured into at least a first flow of measured gas and a second flow of measured gas,
reducing the measured gas content in the second flow of measured gas by varying an influencing variable which influences the quantity of measured gas, wherein the influencing variable is the humidity,
feeding the first flow of measured gas and the second flow of measured gas to a sensor in alternation,
determining a first intermediate measured value in the first flow of measured gas which represents the sum of the content of the measured gas and the content of the interfering further constituent,
determining a second intermediate measured value in the second flow of measured gas which represents the sum of the content of the measured gas and the content of the interfering further constituent, and
calculating the final measured value based on the results of the two intermediate measurements.

12. (canceled)

13. The method according to claim 11, wherein the measured value to be measured is the sulphur dioxide content and the interfering constituent is nitrogen dioxide.

14. The method according to claim 11, wherein the increase in the humidity of the second flow of measured gas means that sulphur dioxide is removed from the second flow of measured gas.

15. The method according to claim 12, wherein the calculation of the final sulphur dioxide measurement result is obtained by subtracting the second measurement result from the first measurement result, wherein first and second measurement results are respectively formed by the sum of the sulphur dioxide and nitrogen dioxide contents.

16. The method according to claim 9, wherein the gas flow is a respiratory gas flow from a medical apparatus.

17. The method according to claim 9, wherein instead of the flows of measured gas, calibration gas is uniformly supplied.

18. The method according to claim 11, wherein the carbon monoxide, nitric oxide, carbon dioxide and oxygen contents are determined, wherein the sulphur dioxide content is determined exclusively in the first flow of measured gas and the carbon monoxide and oxygen contents are exclusively determined in the second flow of measured gas.
